(19) United States
(12) Patent Application Publication
(10) Pub. No.: US 2026/0352936 A1
(43) Pub. Date: Nov. 5, 2026

(54) LIGHT-SHEET GENERATOR AND GENERATION METHOD

(71) Applicant: Cognex Corporation, Natick, MA (US)

(72) Inventors: André Schweier, Freiburg (DE); Khaled Aljasem, Bad Krozingen (DE)

(21) Appl. No.: 19/668,429

(22) Filed: May 5, 2026

Related U.S. Application Data
(60) Provisional application No. 63/800,184, filed on May 5, 2025.

(51) Int. Cl. H04N 23/55; G01B 11/00; G02B 5/02; G02B 19/00

(52) U.S. Cl. CPC H04N 23/55; G01B 11/005; G02B 5/02; G02B 19/0028

(57) ABSTRACT

A light-sheet generator includes a light focuser and an optical diffuser. The light focuser focuses, in a first horizontal plane, a first beam region of an optical beam to yield a first converging beam having a first divergence angle. The light focuser also focuses, in a second horizontal plane, a second beam region of the optical beam to yield a second converging beam having a second divergence angle that differs from the first divergence angle. Respective centers of the first and the second beam regions are spatially separated in a vertical direction that is perpendicular to both the center axis, the first horizontal plane and the second horizontal plane. The optical diffuser diffuses each of the first and the second converging beam to yield a respective first diffused beam and a second diffused beam that at least partially overlap in a vertical plane that is parallel to the vertical direction.

### CROSS-REFERENCE TO RELATED APPLICATION

The present application claims priority to U.S. Provisional Patent Application No. 63/800,184 filed on May 5, 2025, the entire content of which is incorporated herein by reference for all purposes.

### BACKGROUND

Vision systems that perform measurement, inspection, and/or alignment of objects are used in a wide range of applications and industries. These systems are based around the use of an image sensor, which acquires images (typically grayscale or color, and in one, two, or three dimensions) of the subject or object, and processes these acquired images using an on-board or interconnected vision system processor. The processor generally includes both processing hardware and software that perform one or more vision system processes to generate a desired output based upon the image's processed information.

Three-dimensional (3D) displacement sensors based on laser triangulation are widely used in industrial and manufacturing settings for non-contact inspection and precision measurement. These sensors operate by projecting a laser line onto the surface of a target object and capturing the reflected light with a position-sensitive detector. The position of the reflected laser line on the detector shifts based on the distance to the target object, allowing the vision system to geometrically compute precise displacement values.

Laser triangulation sensors are commonly employed for tasks such as inline dimensional verification, surface profiling, flatness or height measurement, and defect detection. The non-contact nature of the sensors is especially well-suited for inspecting delicate, moving, or otherwise sensitive surfaces while minimizing risk of contamination or damage. Additionally, the sensors may be integrated into robotic inspection systems or multi-axis scanning platforms to acquire 3D data of complex structures.

Despite their widespread use, conventional laser triangulation sensors may face challenges in certain scenarios. Various influencing factors are important for the accuracy of the position determination, one of the more important factors being the width of the laser line on the surface to be measured. The thinner, and therefore sharper the laser line is, the more accurately its position can be determined. Accordingly, there is a continuing need for improvements in laser triangulation-based 3D displacement sensing.

An alternative method for improving displacement sensing described above includes using Bessel beams. However, the generation of Bessel beams requires very sophisticated optical components and circularly symmetric beams with a precisely defined and preserved intensity profile (i.e., a precisely defined wavefront). This often necessitates the integration of additional specialized optical technologies, which makes them economically unsuitable for many laser applications.

For lasers with one of the two beam cross-section axes widened for line shaping, only the orthogonal axis needs to be specially shaped. This simplifies the optical components required, but ensuring a precisely defined beam profile under all circumstances remains a challenging task and still requires special technologies.

### SUMMARY OF THE EMBODIMENTS

Embodiments disclosed herein enable 3D displacement sensors with extended working range while avoiding the aforementioned problems with existing solutions.

Embodiments combine the optical process used to form a light sheet with the process for increasing the depth of field in one axis (one plane). A light sheet may have an asymmetric cross-section transverse to the propagation axis, where the longer axis is the decisive transverse axis and is identical to the axis of the laser line axis (not the orthogonal axis/plane). This ensures that the well-defined intensity profile of the laser beam is maintained in its decisive transverse axis.

In a first aspect, a light-sheet generator includes a light focuser and an optical diffuser. The light focuser focuses, in a first horizontal plane, a first beam region of an optical beam to yield a first converging beam having a first divergence angle in the first horizontal plane and with respect to a center axis of the optical beam. The light focuser also focuses, in a second horizontal plane, a second beam region of the optical beam to yield a second converging beam having a second divergence angle in the second horizontal plane, with respect to the center axis, that differs from the first divergence angle. Respective centers of the first and the second beam regions are spatially separated in a vertical direction that is perpendicular to both the center axis, the first horizontal plane and the second horizontal plane. The optical diffuser diffuses each of the first and the second converging beam to yield a respective first diffused beam and a second diffused beam that at least partially overlap in a vertical plane that is parallel to the vertical direction.

In a second aspect, a light-sheet generation method is disclosed. The method includes focusing, in a first horizontal plane, a first beam region of an optical beam to yield a first converging beam having a first divergence angle with respect to a center axis of the optical beam. The method also includes focusing, in a second horizontal plane, a second beam region of the optical beam to yield a second converging beam having a second divergence angle, with respect to the center axis, that differs from the first divergence angle. Respective centers of the first and the second beam regions are spatially separated in a vertical direction that is perpendicular to the center axis, the first horizontal plane, and the second horizontal plane. The method also includes vertically diffusing each of the first and the second converging beam to yield a respective first diffused beam and a second diffused beam that at least partially overlap in a vertical plane that is parallel to the vertical direction.

### BRIEF DESCRIPTION OF THE FIGURES

FIG. 1A is a schematic view of a laser displacement sensor (DS) system that includes an imaging device and a light-sheet generator.

FIG. 1B is a cross-sectional view of a light sheet generated by a lens of the light-sheet generator of FIG. 1A.

FIG. 2A-2D are schematics of a light-sheet generator, which is an example of light-sheet generator of FIG. 1A.

FIG. 3 is a schematic of a light-sheet generator, which is an embodiment of the light-sheet generator of FIG. 2A that includes an optical diffuser.

FIG. 4A-4D are cross-sectional schematics of a first embodiment of the light-sheet generator of FIG. 2A.

FIG. 5A-5D are cross-sectional schematics of a second embodiment of the light-sheet generator of FIG. 2A.

FIG. 6 is a ray trace of a ray bundle transmitted through a light focuser, which is an example of the light focuser of FIG. 5A.

FIG. 7 is a ray trace of the ray bundle of FIG. 6 transmitted through an example of the optical diffuser of FIG. 3.

FIG. 8 is a schematic of a light-sheet generator, which is an embodiment of the light-sheet generator of FIG. 2A.

FIG. 9 is a schematic of a vision system, which is an embodiment of the vision system of FIG. 1A.

FIG. 10 is a flowchart illustrating an embodiment of a light-sheet generation method, which may be implemented by the light-sheet generator of FIG. 2A.

### DETAILED DESCRIPTION OF THE EMBODIMENTS

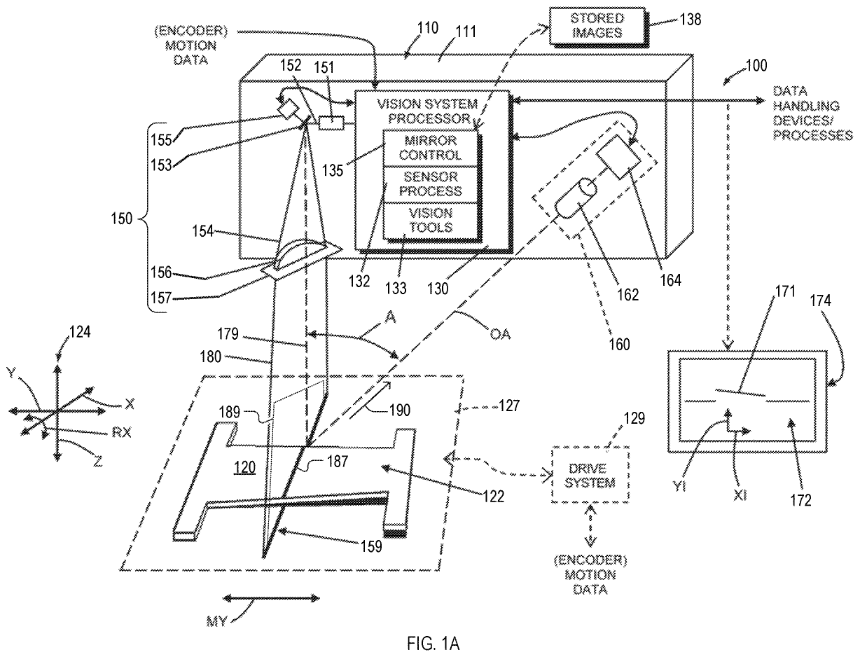

FIG. 1A shows an example of a vision system 100 including a laser displacement sensor 110 oriented to image an object 120 (also sometimes referred to as a “part”). Displacement sensor 110 may be contained in a housing 111 that is mounted at an appropriate location with respect to the imaged scene. In alternate embodiments, the displacement sensor can comprise discrete, separated subcomponents. In an example implementation, object 120 and displacement sensor 110 are in relative motion (double arrow MY) with either displacement sensor 110, the object 120, or both, moving (the scan motion direction) along at least one axis of relative coordinate system 124 (in this example, the physical y-axis direction). In a typical arrangement, object 120 is located on a motion conveyance 127 (shown in phantom) that provides motion data from an encoder or similar device operatively connected to the motion drive system 129 in a manner clear to those of skill in the art.

Also, as described further below, the system and method may be employed on images that are acquired and then stored for further processing. Such images may be transmitted for processing by the system and method (i.e., a filtering process and associated vision system tools) in a manner in which the processor is free of connection to the camera assembly or other image acquisition arrangement.

Object 120 is, by way of example, a structure having a surface 122 that defines a generally three-dimensional (3D) profile, in which (e.g.) the height (i.e., the displacement dimension along the physical z axis) varies with respect to the x-axis and y-axis directions. This is only one example of a wide range of possible surface shapes, and is described as a useful example of the principles of the illustrative embodiment of the system and method. In further examples, the outer, surrounding surface may define a more complex perimeter with different/additional features.

Displacement sensor 110 includes a laser beam assembly 151 that projects a coherent beam 152. A center wavelength of coherent beam 152 may be in the visible or near-IR region of the electromagnetic spectrum. Beam 152 is directed to a moving beam deflector 153 (e.g., a mirror, described in further detail below), which in this embodiment turns a central axis 179 (denoted by a dashed line) of beam 152 by an angle, e.g., by 90 degrees. Note that the depicted 90-degree (right) angle is an example, and the angle of beam deflection can vary widely depending upon the configuration of the system and other desired design criteria. Deflector 153 includes an actuator 155 that causes the deflector to reflect the beam in a lateral, cycling pattern (e.g., left-right). In an embodiment, actuator 155 causes deflector 153 to pivot on an axis between a positive and a negative angle. FIG. 1A denotes a light-sheet generator 150, which includes at least one of linear diffuser 157, lens 156, deflector 153, and actuator 155. Light-sheet generator 150 may also include laser beam assembly 151.

The reflected beam cycles left-right so as to trace out a sweeping fan 154 centered around central axis 179. This beam of the fan passes into an optical structure that may include at least one of a lens 156 and a linear diffuser 157. Lens 156 may be a cylindrical lens. Lens 156 transmits sweeping fan 154 as a planar fan 180 toward object 120 and the surrounding scene in a desired configuration.

As described in detail below, diffuser 157 and moving deflector 153 generate a planar fan 180 having a substantially Gaussian beam with a limited out-of-plane thickness that qualifies as a light sheet 189 of planar fan 180. FIG. 1B shows a Gaussian beam profile of planar fan 180 and a longitudinal range 188 within which planar fan 180 forms light sheet 189. Longitudinal range 188 may be a Rayleigh range (or Rayleigh length) of planar fan 180. FIG. 1B also depicts optical beams 181 and 182. Beam 181 has a narrower beam waist than planar fan 180, but its Rayleigh range is too small for displacement sensing. Beam 182's Rayleigh range is sufficient for displacement sensing, but this increased range comes at the expense of a larger beam waist, and hence decreased beam brightness. Light sheet 189 has both a relatively narrow beam waist and long Rayleigh range.

Light sheet 189 illuminates surface 122, thereby forming a laser line 187 on surface 122, shown in FIG. 1A. The real position of laser line 187 on surface 122 is determined by an analysis of the cross-section of laser line 187. Many methods may be deployed for this determination, one possible being the center-of-gravity of the cross section. All methods depend on an assumed geometry of the image of the cross section. When a discontinuity in surface 122—such as an edge—is illuminated by light sheet 189, the geometry of laser line 187 will be distorted and the deployed method to determine laser line 187's position will produce failures. It is easy to understand that a spatial coincidence of a discontinuity and laser line 187's cross section is less probable for very thin laser lines and the relative failures in determining its position are smaller.

The thickness of line 187 determines the magnitude of its brightness, as a certain light output appears brighter when it is concentrated on a smaller area. As a result, the image of line 187 on image sensor 164 has an intensity that increases as a function of decreasing thickness of line 187, even holding the total optical power of beam 152 constant.

Embodiments of light-sheet generator 150 enable line 187 to be very thin within a larger depth of focus range. So a working range for displacement sensor 110 may be larger and line 187 appears to be brighter and equally bright within the larger working range.

Planar fan 180 intersects the scene to be imaged (e.g., here, object 120 and motion conveyance 127) along an illumination contour 159. Illumination contour 159 is effectively speckle-free and has an effectively uniform thickness regardless of an in-plane displacement of the illumination contour.

As shown, illumination contour 159, also referred to as an illumination line, is defined along the physical x-axis (transverse to the scan motion direction MY). Planar fan 180, in this embodiment, is approximately (or substantially) perpendicular to a reference plane, such as the physical x-y plane of the motion conveyance 127 and/or a plane of surface 122 of object 120. Displacement sensor 110 also includes an imaging device 160 that includes an imaging system 162 and an image sensor 164. Imaging system 162 may be arranged in a Scheimpflug configuration (or any other appropriate optical arrangement that should be clear to those of skill).

Image sensor 164 contains an array of photosensitive pixels defining a predetermined resolution, and imaging device 160 generally defines an optical axis OA that intersects object 120 in the region of illumination contour 159. Camera optical axis OA defines a non-parallel (e.g., acute) angle A with respect to the plane (and associated axis 179) of planar fan 180. Thus, any physical z-axis height variation/displacement in illumination contour 159 along the physical x-axis is imaged by imaging device 160 as a variation in position (along the image axis YI) in resulting line 171 of a two-dimensional (2D) image 172, as shown generally in (optional) user interface display 174.

Note that the depicted arrangement of axes (x, y, z) is a convention, and other representations of relative orientation (e.g., polar coordinates) are expressly contemplated. As shown, rotation about a given axis is also represented, for example, by the double-curved arrow Rx, which depicts rotation about the physical x-axis.

Image sensor 164 is operatively interconnected to a vision system processor 130 that is contained within housing 111 of displacement sensor 110 in this embodiment. In alternate embodiments, some or all of the vision system processor components and/or processes can reside remote from the housing (on an interconnected tablet, laptop, or PC that may be associated with display 174, for example). In embodiments, vision system processor 130 performs a displacement sensor process 132 in accordance with the illustrative embodiment described in detail further below.

Processor 130 may also receive relative motion signals from motion conveyance 127 or another moving device (e.g., a gantry or manipulator holding the displacement sensor and/or the object). Images are acquired in association with such motion signals so that illumination contour 159 is registered with the physical position in the scene. Images may be stored in an appropriate memory or storage location 138 for subsequent transmission and/or analysis. Note that the use of a displacement sensor (DS) assembly with relative motion versus the object under inspection is one example of a wide range of applications in which the line-generation system of this embodiment may be employed. For example, a DS assembly of the type depicted may be employed in a static configuration in various applications-for example to generate static line profiles or cross sections on objects that are stationary (free of relative motion). The reduced-speckle line generated by the illustrative embodiment is beneficial in increasing the accuracy of such measurements.

Displacement sensor 110, or another device, may include/incorporate appropriate vision tools 133, such as edge detectors, line finders, blob analyzers, calipers, etc. Vision tools 133 analyze 3D images provided by image sensor 164, and generate results based upon such analysis. By way of non-limiting example, image data (e.g., a range image or 3D point cloud) and/or analyzed results is/are transmitted to downstream data handling devices and processes for use in various production activities, such as inspection, quality control, object manipulation, assembly, etc.

Processor 130, or another module, may include a mirror/deflector control process(or) 185, which is interconnected to actuator 155. This control 135 operates the deflector at an appropriate cycle rate (frequency), and may be based on the acquisition frame rate of the image sensor 164 so as to ensure that each frame images a sequence of instances of illumination contour 159 corresponding to a complete trace of beam 152 on linear diffuser 157.

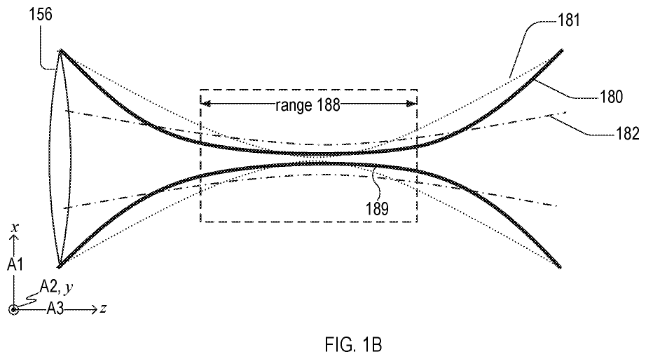

FIG. 2A-2D are schematics of a light-sheet generator 200, which is an example of light-sheet generator 150. Light-sheet generator 200 includes a light focuser 230 and may also include one or both of an input optical diffuser 201 and a beam collimator 202. Figures herein depict orthogonal axes A1, A2, and A3, which are synonymous with axes x, y, and z. Herein, a horizontal plane is parallel to the A1-A3 (x-z) plane and a vertical plane is parallel to the A2-A3 (y-z) plane. FIG. 2A is in a vertical plane, while FIG. 2B-2D are in respective horizontal planes.

FIG. 2A-2D show an optical beam 270 incident on light focuser 230, which transmits optical beam 270 as a converging optical beam 280. Light focuser 230 may be or include one of a cylindrical lens, a tapered cylindrical lens, an acylindrical lens, a diffractive optical element, a cylindrical mirror, an acylindrical mirror, or any combination thereof. Any optical element that focuses a collimated beam to a focal line is an example of light focuser 230. An acylindrical optical lens or mirror is analogous to an aspherical lens or mirror, respectively.)

Optical beam 270 includes beam regions 271, 272, and 273. FIG. 2A depicts horizontal planes 271p, 272p, and 273p, which intersect beam regions 271, 272, and 273, respectively. Optical beam 270 has a beam width 274 along axis A2. Planes 271p, 272p, and 273p may be uniformly distributed along axis A2, such that a vertical separation between two adjacent planes (271p & 272p, 272p & 273p) is approximately one-quarter of beam width 274. Optical beam 270 has a center axis 279. Light focuser 230 may have a cylinder axis oriented at an oblique angle with respect to at least one of center axis 279 and an optical axis of beam collimator 202.

Each of horizontal planes 271p-273p may be parallel to center axis 279, which may be within one of planes 271p-273p. Respective centers of the beam regions 271-273 are spatially separated in a vertical direction that is perpendicular to both center axis 279 and to horizontal planes 271p-273p.

FIGS. 2B, 2C, and 2D depict, respectively, converging beam 281 in horizontal plane 271p, converging beam 282 in horizontal plane 272p, and converging beam 283 in horizontal plane 273p. Light focuser 230 focuses at least two of: beam region 271 to yield converging beam 281, beam region 272 to yield converging beam 282, and beam region 273 to yield converging beam 283. With respect to a center axis 279, converging beams 281, 282, and 283 may have respective and distinct divergence angles 281d, 282d, and 283d such that, in embodiments, no two of divergence angles 281d-283d are equal. Divergence angles 281d-283d are in respective horizontal planes 271p-273p.

In planes 271p, 272p, and 273p, light focuser 230 focuses respective beam regions 271-273 to respective beam-waist locations 241, 242, and 243 as shown in FIGS. 2B-2D. Accordingly, converging beams 281, 282, and 283 have respective beam waists located at respective beam-waist locations 241-243. FIG. 2A shows schematic transverse cross-sections 251, 252, and 253 of converging optical beam 280 in the A1-A2 plane at respective beam-waist locations 241, 242, and 243. Along axis A1, cross-sections 251, 252, and 253 have respective minimum widths 254, 256, and 258 and respective maximum widths 255, 257, and 259.

Herein, beam-waist locations 241-243 are also referred to as beam-waist distances 241-243, which may be measured from a principal plane 230p of light focuser 230. A beam-waist distance, such as distances 241-243, may be a distance, parallel to axis A3 from a vertical plane where principal plane 230p intersects center axis 279. FIG. 2A denotes a longitudinal range 288 within which converging optical beam 280 forms a light sheet 289, e.g., between beam-waist locations 243 and 241. Longitudinal range 288 may be a Rayleigh range (or Rayleigh length) of optical beam 280. Light sheet 289 is an example of light sheet 189.

In embodiments, light-sheet generator 200 forms light sheet 289 primarily or entirely via refraction, and hence does not rely on diffraction or reflection. For example, one or both of beam collimator 202 and light focuser 230 may be refractive optical elements. In embodiments, formation of light sheet 289 does not involve splitting a beam into multiple components (“beamlets”), e.g., via use of a tilted etalon. Accordingly, light sheet 289 may have an intensity and/or thickness profile along axis A2 that is substantially uniform, and hence lacks local maxima characteristic of light sheets formed by splitting and recombining an optical beam using reflective and/or diffractive optical elements. As such, light sheet 289 may be a Gaussian beam in both the horizontal and vertical planes, and hence may be an astigmatic Gaussian beam.

Optical diffuser 201 expands an incident optical beam 270a in the y-z plane and outputs a diverging optical beam 270b. In embodiments, input optical diffuser 201 also expands incident optical beam 270a in the x-z plane. Beam collimator 202 is along an optical beam of incident optical beam 270a between input optical diffuser 201 and beam collimator 202. Beam collimator 202 outputs optical beam 270 and has an optical axis 202z. Center axis 279 of optical beam 270 may be parallel to and/or collinear with optical axis 202z. For clarity of illustration, FIG. 2A shows center axis 279 and 202z as collinear.

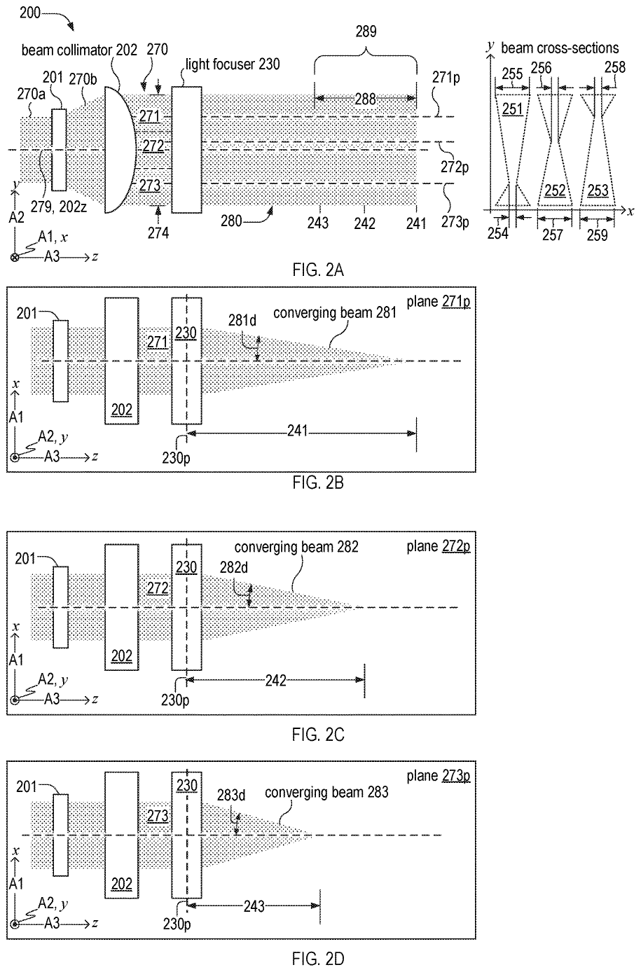

FIG. 3 is a schematic of a light-sheet generator 300, which is an embodiment of light-sheet generator 200 that includes an optical diffuser 360. Optical diffuser 360 may diffuse optical beams incident thereon in vertical planes while not diffusing incident optical beams in horizontal planes. For example, optical diffuser 360 may be, or include, a lenticular diffuser array having a plurality of cylindrical lenslets arrayed in a vertical direction that is perpendicular to the center axis and in the vertical plane. Optical diffuser 360 may include a diffractive optical element. Optical diffuser 360 is an example of linear diffuser 157, FIG. 1A.

Optical diffuser 360 transmits converging optical beam 280 as a diffused optical beam 380, which includes at least two of diffused beams 381, 382, and 383. Optical diffuser 360 diffuses at least two of: converging beam 281 to yield a diffused beam 381, converging beam 282 to yield a diffused beam 382, and converging beam 283 to yield a diffused beam 383. Diffused beams 381-383 at least partially overlap in one or more vertical planes that are parallel to the vertical direction A2 and/or plane A2-A3. As shown in FIG. 3, optical diffuser 360 may produce diffused beams other than diffused beams 381-383. For example, FIG. 3 schematically illustrates diffused beams 381-383 as three of twelve diffused beams output by optical diffuser 360. Each of diffused beams 381-383 may correspond to a respective diffusing element, e.g., a cylindrical lenslet, of optical diffuser 360.

FIG. 3 denotes a longitudinal range 388 within which diffused optical beam 380 forms a light sheet 389. Longitudinal range 388 may extend between beam-waist locations 243 and 241, and may be a Rayleigh range of optical beam 380. Along axis A3, the extent of light sheet 389 may be defined by where diffused beams 381-383 at least partially overlap. Light sheet 389 is an example of light sheet 189.

Optical diffuser 360 homogenizes the focal lines of at least two of converging optical beams 281-283. That is, optical diffuser 360 makes the widths of the focal lines more uniform by decreasing the difference between their minimum width and maximum widths, as shown by schematic transverse cross-sections 351, 352, and 353 shown in FIG. 3. Schematic transverse cross-sections 351, 352, and 353 are of diffused optical beam 380 in the A1-A2 plane at respective beam-waist locations 241, 242, and 243. Hence, transverse cross-sections 351, 352, and 353 may be compared to transverse cross-sections 251, 252, and 253 (FIG. 2A) to illustrate the effect of optical diffuser 360 on at least two of optical beams 281-283. Along axis A1, cross-sections 351, 352, and 353 have respective minimum widths 354, 356, and 358 and respective maximum widths 355, 357, and 359. Minimum widths 354, 356, and 358 are greater than minimum widths 254, 256, and 258, respectively. Maximum widths 355, 357, and 359 are less than maximum widths 255, 257, and 259, respectively.

In addition to homogenizing the focal lines of converging optical beams 281-283, diffuser 360 mixes the respective optical path lengths and thus reduces speckle of light sheet 389.

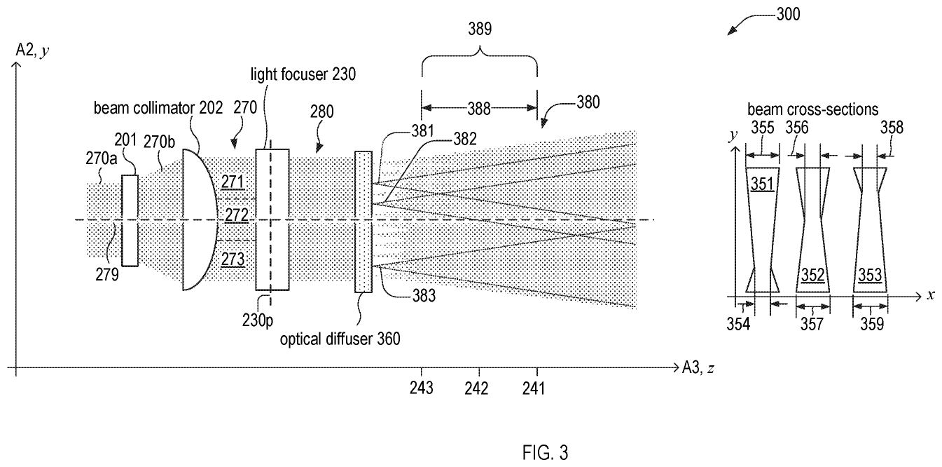

FIG. 4A-4D are cross-sectional schematics of a light-sheet generator 400 that includes a light focuser 430. Light-sheet generator 400 and light focuser 430 are respective examples of light-sheet generator 200 and light focuser 230. Light focuser 430 has a principal plane 430p, which is an example of principal plane 230p. The cross-sectional views of FIG. 4A-4D are equivalent to those of FIG. 2A-2D, respectively.

Light focuser 430 includes at least two of focusing regions 431, 432, and 433. At least part of beam region 271 is incident on focusing region 431. Focusing region 431 has a first optical power in plane 271p and focuses at least part of beam region 271 to yield a converging beam 481. At least part of beam region 272 is incident on focusing region 432. Focusing region 432 has a second optical power in plane 272p and focuses at least part of beam region 272 to yield a converging beam 482. At least part of beam region 273 is incident on focusing region 433. Focusing region 433 has a third optical power in plane 273p and focuses at least part of beam region 273 to yield a converging beam 483. Beams 481-483 are respective examples of converging beams 281-283. One or both of the second and the third optical power differs from the first optical power. The second optical power may differ from the third optical power. One or more of focusing regions 431-433 may be an optical element, such that light focuser 430 may include multiple optical elements.

In embodiments, light focuser 430 has a focal length and/or radius of curvature that varies as a function of position along axis A2, as shown in FIG. 4B-4D. For example, light focuser 430 may be a tapered cylindrical lens that has a cylinder axis parallel to the A2-A3 plane. The cylinder axis may be parallel to the A2 axis. Light focuser 430 has an edge surface 435 and an edge surface 436. As a function of distance from edge surface 435 toward edge surface 436, the radius of curvature of the tapered cylindrical lens may decrease in value, e.g., either continuously (as a monotonically decreasing function) or in discrete steps, such that the radius of curvature at edge surface 435 is smaller than at edge surface 436.

Each of focusing regions 431-433 has optical power in one or more horizontal planes. For example, focusing regions 431-433 have optical power in planes 271p-273p, respectively. One or more of focusing regions 431-433 may be or include a cylindrical lens or a cylindrical mirror.

Each of focusing regions 431-433 may be substantially non-focusing in vertical planes, e.g., the A2-A3 plane. For example, in vertical planes, the optical power of a focusing region 431-433 may be less than one-tenth of its optical power in horizontal planes. In the example of light-sheet generator 400, beam-waist distance 241-243 may correspond to respective focal lengths of focusing regions 431-433.

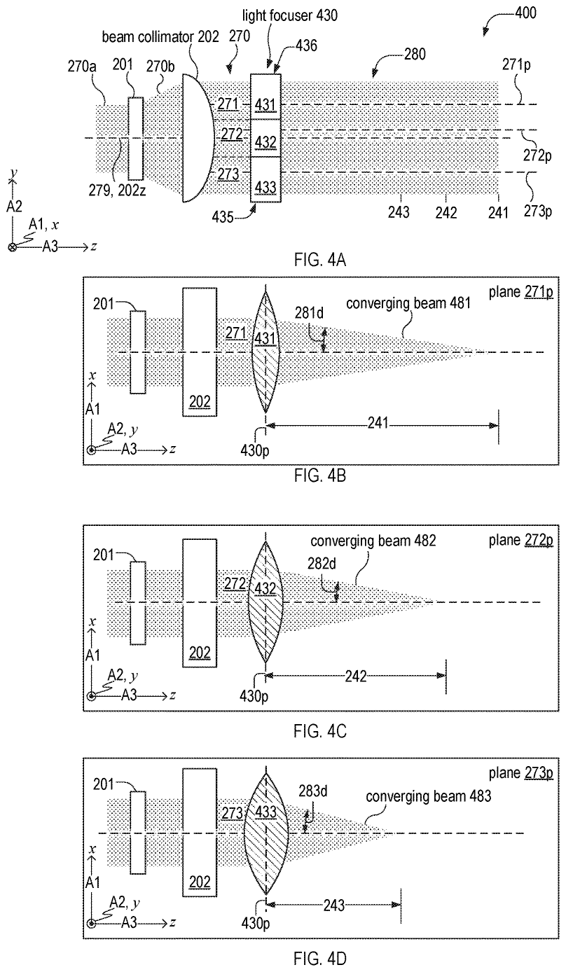

FIG. 5A-5D are cross-sectional schematics of a light-sheet generator 500 that includes a light focuser 530, which transmits optical beam 270 as a converging optical beam 580. Light-sheet generator 500, light focuser 530, and converging optical beam 580 are respective examples of light-sheet generator 200 and light focuser 230, and converging optical beam 280. The cross-sectional views of FIG. 5A-5D are equivalent to those of FIG. 2A-2D, respectively. Light focuser 530 may have a cylinder axis 530a and may be a cylindrical lens.

Axis 530a may be parallel to the A2-A3 plane and may be oriented at an oblique angle 539 with respect to center axis 279 and/or optical axis 202z. Light focuser 530 has a principal plane 530p, which is an example of principal plane 230p. As shown in FIG. 5A, axis 530a may be in principal plane 530p.

Light focuser 530 includes at least two of regions 531, 532, and 533, which focus respective beam regions 271, 272, and 273 to yield respective converging beams 581, 582, and 583, which are respective examples of converging beams 281-283. With respect to a center axis 279, converging beams 581, 582, and 583 may have respective and distinct divergence angles 581d, 582d, and 583d, which are respective examples of 281d, 282d, and 283d.

In planes 271p, 272p, and 273p, light focuser 530 focuses respective beam regions 271-273 to respective beam-waist locations 541, 542, and 543 as shown in FIG. 5B-5D. Beam-waist locations 541-543 are respective examples of beam-waist locations 241-243, and are denoted with respect to where a vertical plane 534 where principal plane 530p intersects center axis 279. When angle 539 is non-zero and oblique, light focuser 530 focuses optical beam 270 to an oblique focal plane 549, which is also oriented at angle 539. Optical beam 580 may be substantially collimated in the vertical plane. For example, in the A2-A3 plane, oblique focal plane 549 may be within the Rayleigh of optical beam 580 (in the A2-A3 plane).

Light focuser 530 may be a tapered cylindrical lens, and hence may achieve a similar effect of focusing optical beam 270 to oblique focal plane 549, even when angle 539 equals zero. In such embodiments, cylinder axis 530a is perpendicular to optical axis 202z and regions 531-533 are at the same axial position in FIGS. 5B, 5C, and 5D.

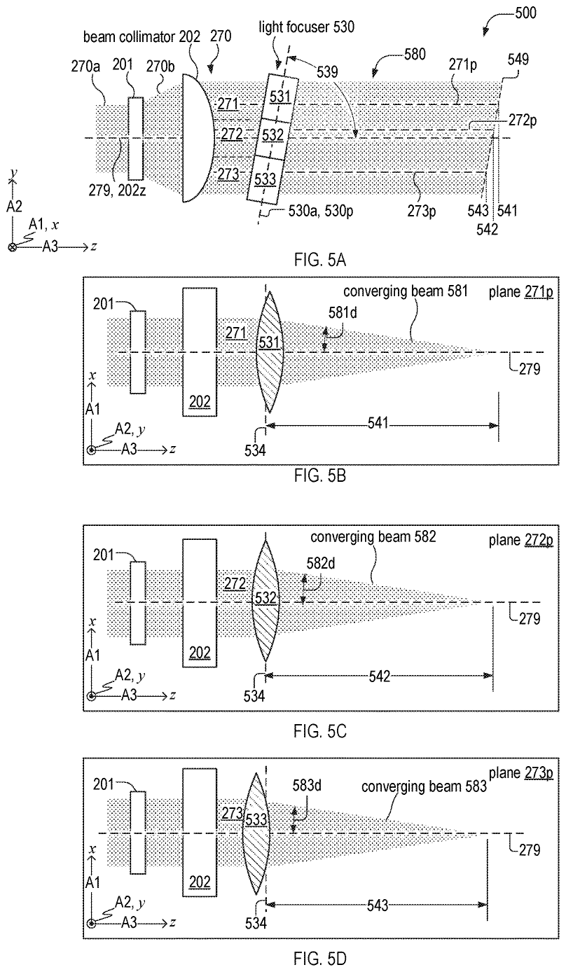

FIG. 6 is a ray trace of a ray bundle 670 transmitted through a light focuser 630, which transmits ray bundle 670 as a converging ray bundle 680. Light focuser 630 and ray bundle 680 are respective examples of light focuser 530 and converging optical beam 580. Ray bundles 670 and 680 are example ray-optics representations of optical beam 270 and converging optical beam 580, respectively. Converging ray bundle 680 converges at an oblique focal plane 649, which is an example of oblique focal plane 549.

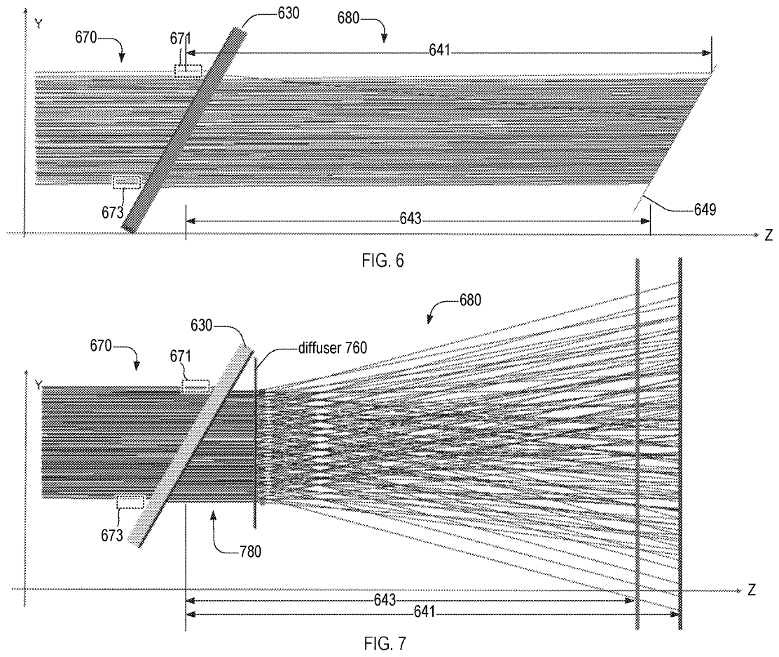

FIG. 7 is a ray trace of ray bundle 670 transmitted through light focuser 630 and ray bundle 680 transmitted through an optical diffuser 760 as a diffused optical beam 780. Optical diffuser 760 and diffused optical beam 780 are respective examples of optical diffuser 360 and diffused optical beam 380. A top region 671 of ray bundle 670 converges at a beam-waist location 641, which is an example of beam-waist location 241. A bottom region 673 of ray bundle 670 converges at a beam-waist location 643, which is an example of beam-waist location 243.

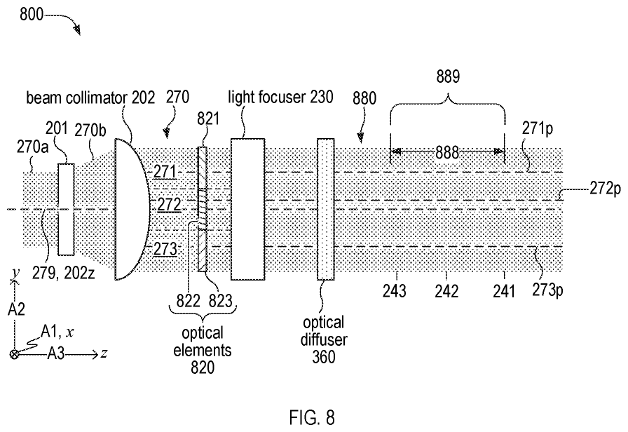

FIG. 8 is a schematic of a light-sheet generator 800, which is an example of light-sheet generator 200 that includes optical elements 820. Light-sheet generator 800 may include optical diffuser 360. Optical elements 820 may be between beam collimator 202 and light focuser 230, as shown in FIG. 8. Alternatively, when light-sheet generator 800 includes optical diffuser 360, optical elements 820 may be between light focuser 230 and optical diffuser 360. In embodiments, optical elements 820 are between diffuser 201 and collimator 202. In other embodiments, optical elements 820 are in front of diffuser 360, such that diffuser 360 is between optical elements 820 and light focuser 230.

Optical elements 820 include one or more of optical elements 821, 822, and 823, which are aligned with and transmit beam regions 271, 272, and 273, respectively. Each of optical elements 821-823 may be a waveplate, such as a half-wave plate, or a spectral filter, such as a band-pass filter, a band-stop filter, a low-pass filter, or a high-pass filter. In embodiments, each optical element 821-823 rotates the polarization of respective beam regions 271-273 by a different angle. For example, each of optical elements 821-823 may be a half-wave plate with its fast-axis oriented at different angles. At least one of incident optical beam 270a and diverging optical beam 270b may be polarized, e.g., linearly polarized, such that beam regions 271-273 have different respective polarization states after being transmitted by optical elements 820.

One or more of optical elements 821, 822, and 823 may correspond to a respective region of one optical element, such as a waveplate array. While optical elements 820 are described as each including three component optical elements (optics 821-823), optical elements 820 may include more or fewer than three optical elements without departing from the scope of the embodiments herein.

Light-sheet generator 800 produces an optical beam 880 that forms a light sheet 889, which are respective examples of planar fan 180 and light sheet 189. FIG. 8 denotes a longitudinal range 888 within which optical beam 880 forms a light sheet 889, e.g., between beam-waist locations 243 and 241. Longitudinal range 888 may be a Rayleigh range (or Rayleigh length) of optical beam 880.

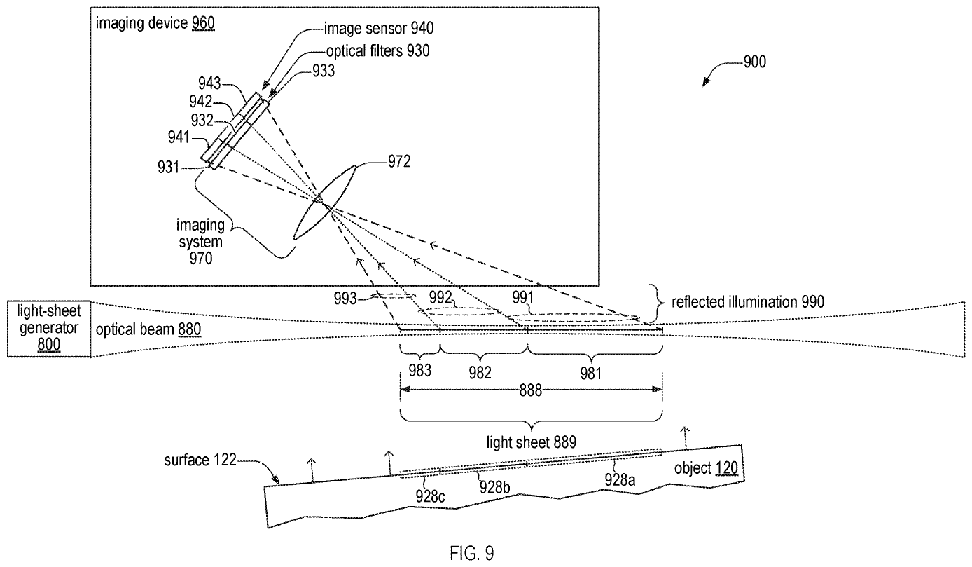

FIG. 9 is a schematic of a vision system 900 that includes an imaging device 960 and light-sheet generator 800. Vision system 900 and imaging device 960 are respective examples of vision system 100 and imaging device 160, FIG. 1A. FIG. 9 shows object 120, introduced in FIG. 1A, moving in toward optical beam 880 such that when surface 122 intersects optical beam 880, it reflects part of optical beam 880 toward imaging device 960 as reflected illumination 990, which is an example of reflected illumination 190 introduced in FIG. 1A. FIG. 9 also denotes beam regions 981, 982, and 983, with longitudinal range 888, the lengths of which may be respective Rayleigh ranges of optical beam 880 originating from respective beam regions 271, 272, and 273 introduced in FIG. 2A.

Imaging device 960 includes an image sensor 940 and an imaging system 970, which are respective examples of image sensor 164 and imaging system 162. Image sensor 940 may be at a focal plane of imaging system 970. Imaging system 970 includes imaging optics 972 and optical filters 930. Optical filters 930 are between imaging optics 972 and image sensor 940. Optical filters 930 may be between image sensor 940 and one or more imaging optics 972.

Optical filters 930 includes one or more of optical filters 931, 932, and 933, which are aligned to a respective region 941, 942, and 943 of image sensor 940. Each of optical filters 931-933 may be a polarizer or a spectral filter. Optical filters 931, 932, and 933 may correspond to a respective region of one optical element, such as a optical filter array. While optical filters 930 are described as each including three component optical elements (optical filters 931-933), optical filters 930 may include more or fewer than three optical elements without departing from the scope of the embodiments herein.

Surface 122 has regions 928a, 928b, and 928c. When surface 122 intersects optical beam 880, regions 928a, 928b, and 928c are illuminated by respective beam regions 981, 982, and 983 of optical beam 880. Imaging device 960 images regions 928a, 928b, and 928c to respective regions 941-943 of image sensor 940. In embodiments, regions 928a, 928b, and 928c reflects respective parts of beam regions 981, 982, and 983 to imaging optics 972 as reflected illumination 991, 992, and 993, which are part of reflected illumination 990. At least part of reflected illumination 991-993 is transmitted through a respective optical filter 931-933 and is incident on a respective region 941-943 of image sensor 940.

In embodiments, each optical filter 931-933 is a polarizer and each of optical elements 821-823 is a half-wave plate with its fast-axis oriented at different angles. As such, optical elements 821-823 rotate the polarization of beam regions 271-273 at different respective angles. These angles may correspond to (e.g., equal) the angle of linear polarization transmitted by respective optical filters 931-933. Each optical filter 931-933, a polarizer in these embodiments, may be configured to select which of reflected illumination 991-993 reaches the respective image-sensor region 941-943 aligned to it. Accordingly, imaging device 960 may function as a polarization-selective triangulation sensor.

Alternatively, imaging device 960 may function as a wavelength-selective triangulation sensor. In such embodiments, each of optical filters 931-933 and optical elements 821-823 are spectral filters. Hence, each of optical elements 821-823 transmits a different spectral band, such that they transmit a different spectral bands of beam regions 271-273. As such, each optical filter 931-933 may be configured to select which of reflected illumination 991-993 reaches the respective image-sensor region 941-943 aligned to it.

Example features of pass bands and stop bands of optical filters 931-933 and optical elements 821-823 include the following. Optical filter 931 and optical element 821 may have the same pass bands and stop bands, optical filter 932 and optical element 822 may have the same pass bands and stop bands, and optical filter 933 and optical element 823 may have the same pass bands and stop bands.

In at least one spectral band, two or more of optical filters 931-933 may be spectrally orthogonal, and at least two of optical elements 821-823 may be spectrally orthogonal. For example, when optical elements 821 and 822 are spectrally orthogonal, a pass band of optical element 821 is within a stop band of optical element 822, and a pass band of optical element 822 is within a stop band of optical element 821. In embodiments, optical elements 821-823 and optical filters 931-933 are spectrally orthogonal in the following sense: each of optical element 821 and optical filter 931 is a red spectral filter, each of optical element 822 and optical filter 932 is a green spectral filter, and each of optical element 823 and optical filter 933 is a blue spectral filter.

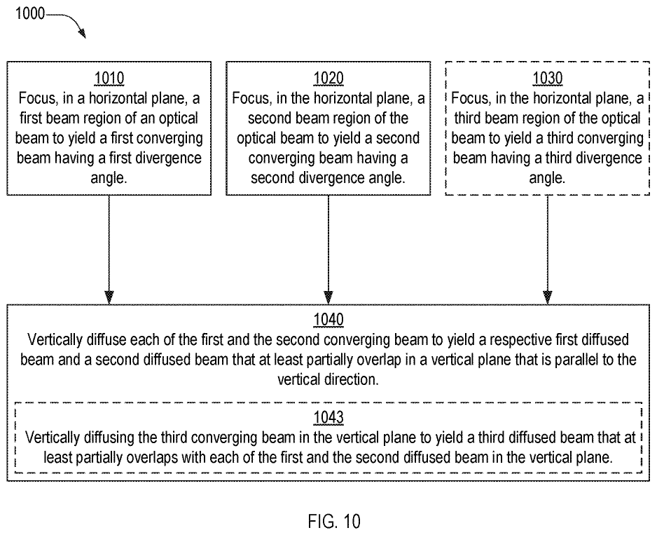

FIG. 10 is a flowchart illustrating a light-sheet generation method 1000, which may be implemented by one or more aspects of light-sheet generator 300. Method 1000 includes at least one of steps 1010, 1020, 1030, and 1040. Light focuser 230 may at least partially implement each of steps 1010, 1020, and 1030. Optical diffuser 360 may implement step 1040.

The following description of method 1000 includes parenthetical numbers following terms recited by the method. The parenthetical number indicates that the element associated with the number in parentheses is an example of the term. For example, the description of step 1010 below recites “a first beam region (271),” which means that beam regions 271 introduced in FIG. 2A is an example of the first beam region introduced in step 1010.

Step 1010 includes focusing, in a first horizontal plane (271p), a first beam region (271) of an optical beam (270) to yield a first converging beam (281) having a first divergence angle (281d) with respect to a center axis (279) of the optical beam.

Step 1020 includes focusing, in a second horizontal plane (272p), a second beam region (272) of the optical beam to yield a second converging beam (282) having a second divergence angle (282d), with respect to the center axis, that differs from the first divergence angle. Respective centers of the first and the second beam regions are spatially separated in a vertical direction (A2) that is perpendicular to both the center axis, the first horizontal plane, and the second horizontal plane.

Step 1030 includes focusing, in a third horizontal plane (273p), a third beam region (273) of the optical beam to yield a third converging beam (283) having a third divergence angle (283d), with respect to the center axis, that differs from each of the first and the second divergence angles. A center of the third beam region is spatially separated from the respective centers of the first and the second beam regions in the vertical direction. In the vertical plane, the second beam region may be between the first and the third beam regions. In the horizontal plane, the first, the second, and the third converging beams may have a respective first, second, and third divergence angle, wherein the second divergence angle exceeds the first divergence angle and is less than the third divergence angle.

Step 1010 may include transmitting the first beam region through a first region (531) of an optical element (530). Step 1020 may include transmitting the second beam region through a second region (532) of the optical element. Step 1030 may include transmitting the third beam region through a third region (533) of the optical element.

Each of the first, the second, and the third converging beam may be substantially collimated in the vertical plane. In embodiments, along the center axis, the first converging beam has a first beam-waist location that differs from a second beam-waist location of the second converging beam and a third beam-waist location of the third converging beam.

Step 1040 includes vertically diffusing each of the first and the second converging beam to yield a respective first diffused beam (381) and a second diffused beam (382) that at least partially overlap in a vertical plane (A2-A3) that is parallel to the vertical direction. When method 1000 includes step 1040, step 1040 may include step 1043. Step 1043 includes diffusing the third converging beam in the vertical plane to yield a third diffused beam (383) that at least partially overlaps with each of the first and the second diffused beam in the vertical plane.

The first converging beam and the second converging beam have a respective first Rayleigh length and a second Rayleigh length along the center axis. Step 1040 may yield a light sheet (389), formed at least in part by the first and the second diffused beam, having a Rayleigh length (388) that exceeds each of the first and the second Rayleigh length.

### Combinations of Features

Features described above, as well as those claimed below, may be combined in various ways without departing from the scope hereof. The following enumerated examples illustrate some possible, non-limiting combinations.

Embodiment 1. A light-sheet generator comprising: a light focuser that (i) focuses, in a first horizontal plane, a first beam region of an optical beam to yield a first converging beam having a first divergence angle in the first horizontal plane and with respect to a center axis of the optical beam and (ii) focuses, in a second horizontal plane, a second beam region of the optical beam to yield a second converging beam having a second divergence angle in the second horizontal plane, with respect to the center axis, that differs from the first divergence angle, respective centers of the first and the second beam regions being spatially separated in a vertical direction that is perpendicular to both the center axis, the first horizontal plane and the second horizontal plane; and an optical diffuser that diffuses each of the first and the second converging beams to yield a respective first diffused beam and a second diffused beam that at least partially overlap in a vertical plane that is parallel to the vertical direction.

Embodiment 2. The light-sheet generator of embodiment 1, wherein: the light focuser (iii) focuses, in a third horizontal plane, a third beam region of the optical beam to yield a third converging beam having a third divergence angle, with respect to the center axis, that differs from each of the first and the second divergence angles, wherein a center of the third beam region is spatially separated from the respective centers of the first and the second beam regions in the vertical direction; and the optical diffuser diffuses the third converging beam in the vertical plane to yield a third diffused beam that at least partially overlaps with each of the first and the second diffused beam in the vertical plane.

Embodiment 3. The light-sheet generator of either of embodiments 1 or 2, the light focuser comprising one of a cylindrical lens and a cylindrical mirror.

Embodiment 4. The light-sheet generator of embodiment 3, the light focuser having a cylinder axis oriented at an oblique angle with respect to the center axis.

Embodiment 5. The light-sheet generator of any of embodiments 1-4, the light focuser comprising: a first optical element that focuses the first beam region and has a first optical power in the first horizontal plane that is perpendicular to the vertical plane; and a second optical element that focuses the second beam region and has a second optical power, in the second horizontal plane, that differs from the first optical power.

Embodiment 6. The light-sheet generator of embodiment 5, each of the first and the second optical elements being substantially non-focusing in the vertical plane.

Embodiment 7. The light-sheet generator of either of embodiments 5 or 6, further comprising: a third optical element that focuses a third beam region of the optical beam and has a third optical power, in a third horizontal plane, that differs from each of the first and the second optical power.

Embodiment 8. The light-sheet generator of any of embodiments 1-6, the optical diffuser including a lenticular diffuser array having a plurality of cylindrical lenslets arrayed in a vertical direction that is perpendicular to the center axis and in the vertical plane.

Embodiment 9. The light-sheet generator of any of embodiments 1-8, further comprising an additional optical diffuser that expands the optical beam before the optical beam reaches the light focuser.

Embodiment 10. The light-sheet generator of embodiment 9, further comprising a beam collimator along an optical path of the optical beam between the additional optical diffuser and the light focuser.

Embodiment 11. The light-sheet generator of any of embodiments 1-10, further comprising: a first waveplate and a second waveplate. The first waveplate transmits the first beam region and has a first fast-axis orientation such that the first diffused beam has a first polarization state. The second waveplate transmits the second beam region and has a second fast-axis orientation that differs from the first fast-axis orientation such that the second diffused beam has a second polarization state differing from the first polarization state.

Embodiment 12. A vision system comprising: the light-sheet generator of embodiment 11, an imaging system having a field of view and a focal plane, a first polarizer, and a second polarizer. Overlapping parts of the first and the second diffused beams form at least part of the light-sheet. The image sensor is at the focal plane and has a first image-sensor region and a second-image-sensor region that is distinct from the first image-sensor region. The first polarizer is aligned to the first image-sensor region, transmits the first polarization state, and blocks the second polarization state. The second polarizer is aligned to the second image-sensor region, blocks the first polarization state, and transmits the second polarization state. When an object in the field of view reflects part of the light-sheet, the imaging system images part of the first and the second diffused beams to the first and the second image-sensor regions, respectively.

Embodiment 13. The light-sheet generator of embodiment 1, further comprising: a first spectral filter that transmits a first spectral band of the first beam region such that the first diffused beam has a first optical spectrum corresponding to the first spectral band; and a second spectral filter that transmits a second spectral band of the second beam region such that the second diffused beam has a second optical spectrum corresponding to the second spectral band; wherein the second spectral band differs from the first spectral band.

Embodiment 14. A vision system comprising: the light-sheet generator of embodiment 13, overlapping parts of the first and the second diffused beams forming at least part of a light-sheet; an imaging system having a field of view and a focal plane; an image sensor at the focal plane and having a first image-sensor region and a second image-sensor region that is distinct from the first image-sensor region; a third spectral filter, aligned to the first image-sensor region, that transmits the first spectral band and blocks the second spectral band; and a fourth spectral filter, aligned to the second image-sensor region, that blocks the first spectral band and transmits the second spectral band; wherein when an object in the field of view reflects part of the light-sheet, the imaging system images part of the first and the second diffused beams to the first and the second image-sensor regions, respectively.

Embodiment 15. A light-sheet generation method, comprising: focusing, in a first horizontal plane, a first beam region of an optical beam to yield a first converging beam having a first divergence angle with respect to a center axis of the optical beam; focusing, in a second horizontal plane, a second beam region of the optical beam to yield a second converging beam having a second divergence angle, with respect to the center axis, that differs from the first divergence angle, wherein respective centers of the first and the second beam regions are spatially separated in a vertical direction that is perpendicular to the center axis, the first horizontal plane, and the second horizontal plane; and vertically diffusing each of the first and the second converging beams to yield a respective first diffused beam and a second diffused beam that at least partially overlap in a vertical plane that is parallel to the vertical direction.

Embodiment 16. The method of embodiment 15, the first converging beam and the second converging beam having a respective first Rayleigh length and a second Rayleigh length along the center axis, wherein: said vertically diffusing yields a light sheet, formed at least in part by the first and the second diffused beam, having a Rayleigh length that exceeds each of the first and the second Rayleigh length.

Embodiment 17. The method of either one of embodiments 14 or 15, each of the first converging beam and the second converging beam being substantially collimated in the vertical plane.

Embodiment 18. The method of any one of embodiments 15-17, along the center axis, the first converging beam having a first beam-waist location that differs from a second beam-waist location of the second converging beam.

Embodiment 19. The method of any one of embodiments 15-18, further comprising: focusing, in a third horizontal plane, a third beam region of the optical beam to yield a third converging beam having a third divergence angle, with respect to the center axis, that differs from each of the first and the second divergence angles, wherein a center of the third beam region is spatially separated from the respective centers of the first and the second beam regions in the vertical direction; wherein diffusing further includes diffusing the third converging beam in the vertical plane to yield a third diffused beam that at least partially overlaps with each of the first and the second diffused beam in the vertical plane.

Embodiment 20. The method of embodiment 19, in the vertical plane, the second beam region being between the first and the third beam regions; and in the horizontal plane, the first, the second, and the third converging beams having a respective first, second, and third divergence angle, wherein the second divergence angle exceeds the first divergence angle and is less than the third divergence angle.

Embodiment 21. The method of any one of embodiments 15-20, wherein focusing the first beam region comprises transmitting the first beam region through a first region of an optical element; and focusing the second beam region comprises transmitting the second beam region through a second region of the optical element.

Embodiment 22. The method of embodiment 21, wherein in the vertical plane, a cylindrical axis of the optical element is oriented at an oblique angle with respect to the center axis.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments.

Regarding instances of the terms “and/or” and “at least one of,” for example, in the cases of “A and/or B,” “at least one of A and B,” and “at least one of A or B,” such phrasing encompasses the selection of (i) A only, or (ii) B only, or (iii) both A and B. In the cases of “A, B, and/or C, ” “at least one of A, B, and C,” and “at least one of A, B, or C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

The following claims are intended to cover all generic and specific features described herein, as well as all statements of the scope of the present method and system, which, as a matter of language, might be said to fall therebetween.

We claim:

1. A light-sheet generator comprising:
a light focuser that (i) focuses, in a first horizontal plane, a first beam region of an optical beam to yield a first converging beam having a first divergence angle in the first horizontal plane and with respect to a center axis of the optical beam and (ii) focuses, in a second horizontal plane, a second beam region of the optical beam to yield a second converging beam having a second divergence angle in the second horizontal plane, with respect to the center axis, that differs from the first divergence angle, respective centers of the first and the second beam regions being spatially separated in a vertical direction that is perpendicular to both the center axis, the first horizontal plane and the second horizontal plane; and
an optical diffuser that diffuses each of the first and the second converging beams to yield a respective first diffused beam and a second diffused beam that at least partially overlap in a vertical plane that is parallel to the vertical direction.

2. The light-sheet generator of claim 1, wherein:
the light focuser (iii) focuses, in a third horizontal plane, a third beam region of the optical beam to yield a third converging beam having a third divergence angle, with respect to the center axis, that differs from each of the first and the second divergence angles, wherein a center of the third beam region is spatially separated from the respective centers of the first and the second beam regions in the vertical direction; and
the optical diffuser diffuses the third converging beam in the vertical plane to yield a third diffused beam that at least partially overlaps with each of the first and the second diffused beam in the vertical plane.

3. The light-sheet generator of claim 1, the light focuser comprising one of a cylindrical lens and a cylindrical mirror.

4. The light-sheet generator of claim 3, the light focuser having a cylinder axis oriented at an oblique angle with respect to the center axis.

5. The light-sheet generator of claim 1, the light focuser comprising:
a first optical element that focuses the first beam region and has a first optical power in the first horizontal plane that is perpendicular to the vertical plane; and
a second optical element that focuses the second beam region and has a second optical power, in the second horizontal plane, that differs from the first optical power.

6. The light-sheet generator of claim 5, each of the first and the second optical elements being substantially non-focusing in the vertical plane.

7. The light-sheet generator of claim 5, further comprising:
a third optical element that focuses a third beam region of the optical beam and has a third optical power, in a third horizontal plane, that differs from each of the first and the second optical power.

8. The light-sheet generator of claim 1, the optical diffuser including a lenticular diffuser array having a plurality of cylindrical lenslets arrayed in a vertical direction that is perpendicular to the center axis and in the vertical plane.

9. The light-sheet generator of claim 1, further comprising an additional optical diffuser that expands the optical beam before the optical beam reaches the light focuser.

10. The light-sheet generator of claim 9, further comprising a beam collimator along an optical path of the optical beam between the additional optical diffuser and the light focuser.

11. The light-sheet generator of claim 1, further comprising:
a first waveplate that transmits the first beam region and has a first fast-axis orientation such that the first diffused beam has a first polarization state; and
a second waveplate that transmits the second beam region and has a second fast-axis orientation that differs from the first fast-axis orientation such that the second diffused beam has a second polarization state differing from the first polarization state.

12. A vision system comprising:
the light-sheet generator of claim 11, overlapping parts of the first and the second diffused beams forming at least part of a light-sheet;
an imaging system having a field of view and a focal plane;
an image sensor at the focal plane and having a first image-sensor region and a second image-sensor region that is distinct from the first image-sensor region;
a first polarizer, aligned to the first image-sensor region, that transmits the first polarization state and blocks the second polarization state; and
a second polarizer, aligned to the second image-sensor region, that blocks the first polarization state and transmits the second polarization state;
wherein when an object in the field of view reflects part of the light-sheet, the imaging system images part of the first and the second diffused beams to the first and the second image-sensor regions, respectively.

13. The light-sheet generator of claim 1, further comprising:
a first spectral filter that transmits a first spectral band of the first beam region such that the first diffused beam has a first optical spectrum corresponding to the first spectral band; and
a second spectral filter that transmits a second spectral band of the second beam region such that the second diffused beam has a second optical spectrum corresponding to the second spectral band;
wherein the second spectral band differs from the first spectral band.

14. A vision system comprising:
the light-sheet generator of claim 13, overlapping parts of the first and the second diffused beams forming at least part of a light-sheet;
an imaging system having a field of view and a focal plane;
an image sensor at the focal plane and having a first image-sensor region and a second image-sensor region that is distinct from the first image-sensor region;
a third spectral filter, aligned to the first image-sensor region, that transmits the first spectral band and blocks the second spectral band; and
a fourth spectral filter, aligned to the second image-sensor region, that blocks the first spectral band and transmits the second spectral band;
wherein when an object in the field of view reflects part of the light-sheet, the imaging system images part of the first and the second diffused beams to the first and the second image-sensor regions, respectively.

15. A light-sheet generation method, comprising:
focusing, in a first horizontal plane, a first beam region of an optical beam to yield a first converging beam having a first divergence angle with respect to a center axis of the optical beam;
focusing, in a second horizontal plane, a second beam region of the optical beam to yield a second converging beam having a second divergence angle, with respect to the center axis, that differs from the first divergence angle, wherein respective centers of the first and the second beam regions are spatially separated in a vertical direction that is perpendicular to the center axis, the first horizontal plane, and the second horizontal plane; and
vertically diffusing each of the first and the second converging beams to yield a respective first diffused beam and a second diffused beam that at least partially overlap in a vertical plane that is parallel to the vertical direction.

16. The method of claim 15, the first converging beam and the second converging beam having a respective first Rayleigh length and a second Rayleigh length along the center axis, wherein:
said vertically diffusing yields a light sheet, formed at least in part by the first and the second diffused beam, having a Rayleigh length that exceeds each of the first and the second Rayleigh length.

17. The method of claim 15, each of the first converging beam and the second converging beam being substantially collimated in the vertical plane.

18. The method of claim 15, along the center axis, the first converging beam having a first beam-waist location that differs from a second beam-waist location of the second converging beam.

19. The method of claim 15, further comprising:
focusing, in a third horizontal plane, a third beam region of the optical beam to yield a third converging beam having a third divergence angle, with respect to the center axis, that differs from each of the first and the second divergence angles, wherein a center of the third beam region is spatially separated from the respective centers of the first and the second beam regions in the vertical direction;
wherein diffusing further includes diffusing the third converging beam in the vertical plane to yield a third diffused beam that at least partially overlaps with each of the first and the second diffused beam in the vertical plane.

20. The method of claim 19,
in the vertical plane, the second beam region being between the first and the third beam regions; and
in the horizontal plane, the first, the second, and the third converging beams having a respective first, second, and third divergence angle, wherein the second divergence angle exceeds the first divergence angle and is less than the third divergence angle.

21. The method of claim 15,
focusing the first beam region comprising transmitting the first beam region through a first region of an optical element; and
focusing the second beam region comprising transmitting the second beam region through a second region of the optical element.

22. The method of claim 21, in the vertical plane, a cylindrical axis of the optical element being oriented at an oblique angle with respect to the center axis.
